(19) United States
(12) Patent Application Publication
(10) Pub. No.: US 2015/0088555 A1
(43) Pub. Date: Mar. 26, 2015

(54) RETIREMENT INCOME ASSURANCE POLICY

(71) Applicant: Paul D. Hinson, Sugarland, TX (US)

(72) Inventor: Paul D. Hinson, Sugarland, TX (US)

(73) Assignee: Pension Advisory Group, Richmond, TX (US)

(21) Appl. No.: 14/035,488

(22) Filed: Sep. 24, 2013

(51) Int. Cl. G06Q 40/08

(52) U.S. Cl. CPC G06Q 40/08
USPC 705/4

(57) ABSTRACT

The disclosure relates to certain insurance procedures, methodology and implementation. More specifically, the procedures and methodology relate to insurance or policies which allow for retirement plan contribution when an individual is disabled and is no longer able to receive pay from an employer.

### FIELD

The disclosure relates to certain insurance procedures, methodology and implementation. More specifically, the procedures and methodology relate to insurance or policies which allow for retirement plan contribution when an individual is disabled and is no longer able to receive pay from an employer.

### BACKGROUND

Many different retirement plans exist on the market today. However, the defined contribution or 401 (k) plan currently is the most popular type of plan for the American worker to save money for retirement.

There are currently over 30 million individual 401(k) plan participants in the United States. These plans have over one trillion dollars in assets, which exceeds the total assets in all other types of plans combined. Approximately 88% of these plans permit the employee, to a limited extent, to choose and/or modify the particular securities in which the employee's money is invested.

Among the advantages of 401(k) plans are that, since the employee does not pay any income tax on the percentage of his/her compensation that is contributed to the plan, such contributions effectively realize an immediate percentage gain defined by the employee's current tax bracket (which amount the employee would otherwise have to pay in income tax if the employee took the compensation in cash). Additionally, neither employer matching contributions nor employer discretionary profit-sharing contributions are subject to taxation when made to the plan. Further, the employee typically is able to choose among a number of different investment securities such as mutual stock funds, bond funds, cash management funds, and the like in which to invest the contributed funds, and normally he/she can move funds from one security to another thereby changing the relative percentage contributed to the different funds of the plan on an ongoing basis.

Still further, should the employee separate from his/her employer, unlike a pension or defined benefit plan, the employee's vested 401(k) funds can be rolled over either to a personal IRA (Individual Retirement Account) or to the 401(k) plan of a new employer.

One problem with current 401(k) plans occurs when an employee becomes disabled, e.g. as a result of injury or illness, and is no longer able to work either permanently or for an extended period of time. During this period of disability, the employee is not receiving regular compensation and therefore cannot continue to make contributions to the retirement plan from periodic paychecks. In fact, even if the disabled employee had available funds from which to make contributions to the retirement plan, such would normally not be permitted as the disabled employee is not an active worker and therefore would not be eligible to make ongoing contributions.

Contributions to a 401(k), 403(b) or 457 plan cannot be made by an employee or an employer unless the employee is currently receiving pay, such as disability compensation from the employer. Typically the employee must make the election to contribute to the plan from that pay before the pay has been made to and received by the employee.

Under IRC section 415(c)(3)(c) and Regulation sections 1.415-2(e)(3) and 1.415-4(g), compensation to a disabled employee is imputed at pre-disability levels if the employee is actually receiving some pay. Unfortunately this is a very rare occurrence.

In other words, if an employee becomes disabled, the employee can no longer participate in the qualified retirement plan if the employee is not actively on the payroll of a company. Further, the employee is prohibited from making elective deferrals and the employer is prohibited from making contributions on the behalf of the employee.

According to “Injury Facts” released in 2006 by the National Safety Council, in the United States alone, a fatal injury occurs in the home every 14 minutes. Additionally, a disability injury occurs in the home every four seconds. Like injuries in the home, there is a motor vehicle crash every eleven minutes, and every 13 seconds there is an auto-related disability. Overall, in the home, in automobiles and everywhere else, over 400 Americans become disabled every 10 minutes.

Regarding the severity of disabilities, 43% of people age 40 and above will have a long-term disability event prior to age 65, according the JHA Disability FactBook, 2006 edition. The consequences of long-term disabilities are dire. A 35 year old white collar worker who suffers a disability lasting 90 days or longer will be out of work an average of about six years.

In particular, a computer network system for administering a retirement plan financial product is needed that includes a disability insurance contract that is for the benefit of retirement plan participants. A disability insurance contract insures a participant under a retirement plan against the inability to continue retirement plan contributions due to disability. Premiums due under the insurance contract are paid by the employer. The benefits paid under a disability insurance contract are paid into a separate trust and further allocated to participants'. Further, the benefits paid under the insurance contract are not distributable to the insured participant until the participant is eligible to receive plan distributions as a result of attaining normal retirement age as defined in the retirement plan.

### SUMMARY

Particular embodiments of the invention disclosed herein pertain to a computer implemented method for pension supplementation when an employee has a long-term disability. In this embodiment the computer-implemented method comprises: an employer computer, the employer computer having an interface for sending and retrieving data, wherein the interface is connected by a network.

Further, the method comprises a financial services computer, the financial services computer having an interface for sending and receiving data, wherein the interface is connected to the network and the network is connected to the employer computer; wherein an employer enters data and sends funds through the employer computer to the financial services computer.

Still further, the aforementioned method comprises a bank computer, the bank computer having an interface for sending and receiving data, wherein the interface is connected to the network and the network is connected to the financial services computer; wherein the financial services computer sends funds through the network to the bank computer; and wherein the employer computer sends funds and optionally disabled employee data via the network to the financial services computer upon disablement of the employee, the financial services computer sends the funds via the network to the bank computer, and wherein the bank acts as a trustee for the disabled employee and disperses funds to the disabled employee upon the employee reaching retirement age.

In further embodiments of the invention, the method further comprises the financial services company computer sending data through the network to a third party administrator computer having an interface. In such embodiments, the third party administrator computer sends data through the network to the financial services company computer, the data comprising processed insurance claims on an employee benefit program for the employee.

In certain embodiments, the employer computer sends funds to the bank computer in equal or lesser or greater amount to what the employee would have contributed to the retirement plan if employed by the employer. In other embodiments, the employer computer sends funds to the bank computer in equal, lesser or greater amount to what the employer would have contributed to the employee's retirement plan if the employee was under employment by the employer. In other embodiments, the funds are sent from the employer computer to the financial services computer daily, weekly, bimonthly, monthly, biyearly, yearly, or as a single lump sum.

In additional embodiments of the invention, the bank computer sends data through the network to a third party trustee annuity advisor computer also having an interface. In such embodiments, the third party trustee annuity advisor computer sends data through the network to the bank computer, the data comprising instructions on selecting an annuity provider, selecting an annuity to purchase, instructions on adhering to the terms of the trust, or a combination thereof.

In further embodiments involving the financial services computer, the financial services computer sends data through the network to a cash flow trustee computer operatively connected to the bank computer, the cash flow trustee computer further being operatively connected to an annuities trustee computer. In such embodiments, the third party trustee annuity advisor computer sends data through the network to the annuities trustee computer.

In further embodiments pertaining to the employer computer, the employer computer sends data to the financial services computer comprising the employee's age, retirement benefit contribution plan, type of injury, expectation of duration of disability, employee's gender, employee's health conditions, employee's previous injuries, or a combination thereof.

In further embodiments regarding the financial services computer, the financial services computer sends data regarding the processed insurance claims on the employee benefit program for the employee to an underwriter computer and vice versa.

In still further embodiments regarding the financial services computer, the data sent by the financial services computer to the bank computer comprises monthly disability claim payments for the benefit of the employee, a final lump sum payment for the benefit of the employee or a combination thereof.

In further methods concerning the bank computer, the bank computer sends, through the network, annuity payments at the employees' retirement to a second bank computer in which the employee has a bank account. Alternatively, the bank computer sends annuity payments at the employees' retirement to a printer operatively connected to the bank, wherein the printer prints out a check for the employee.

Further embodiments of the invention comprise a system in which the aforementioned methods are implemented.

### BRIEF DESCRIPTION OF THE DRAWINGS

FIG. 1 is a flowchart illustrating the methods of the invention

FIG. 2 is a detailed flowchart illustrating the methods of the invention.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure are able to be embodied in practice.

We mean and intend the following definitions and explanations to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “Covered Individual” means and refers to an individual for which the Employer has paid premiums in order that contributions will be made to a trust for the individual should he/she become disabled.

As used herein, the term “Monthly Income” means and refers to the monthly average of the employee's compensation considered eligible under the Retirement Plan. As of any date, the average is computed for the period after the employee became eligible for the Retirement Plan.

As used herein, the term “Occupation” means and refers to the Occupation of the Covered Individual as stated in the SCHEDULE, for which coverage was rated.

As used herein, the term “Participate” means and refers to that the Covered Individual is physically able to actively engage in the major duties of his or her Occupation as stated in the SCHEDULE.

As used herein, the term “Permanent Total Disablement, Permanently Totally Disabled or Permanent Total Disability” means and refers to the Covered Individual has suffered Total Disablement and that, as a result of the Accidental Bodily Injury or Sickness or Disease directly causing the Total Disablement, a Physician has certified that the Covered Individual is expected to continue to be Totally Disabled from his or her Occupation as stated in the SCHEDULE for the remainder of his or her lifetime.

As used herein, the term “Physician” means and refers to a doctor of medicine or osteopathy who is: 1. licensed to practice medicine and prescribe and administer drugs or perform surgery; and 2. legally qualified as a medical practitioner operating within the scope of his or her license in the state or jurisdiction where services are rendered.

As used herein, the term “employer” means and refers to the person or entity who applied for insurance in respect of the Covered Individual. The employer will pay the required premium. The Policy Holder must have a valid insurable interest or obligation to the Covered Individual as evidenced by an executed contract or other documentation defining such insurable interest.

As used herein, the term “Pre-existing Condition” means and refers to a condition for which: 1. medical advice or treatment was recommended by or received from a Physician during the six (6) month period preceding the Effective Date of this coverage; or 2. symptoms were present during the six (6) month period preceding the Effective Date of this insurance which would cause a prudent person to seek medical attention.

As used herein, the term “Retirement Account” means and refers to an account for Contributions under the Retirement Plan.

As used herein, the term “Retirement Plan” means and refers to the retirement plan of the employer.

According to the present invention, a retirement plan financial product includes a long-term disability insurance policy or contract as a component of the underlying plan.

In certain embodiments, the plan has a guaranteed issuance, wherein there is no individual underwriting for insurability. In other embodiments, the occupation of the employee is taken into account and there is individual underwriting for insurability. In certain cases wherein the occupation is taken into account, greater insurability is for white collar jobs and employees with low risk hobbies or activities. In other cases, wherein occupation is taken into account, there is less insurability for hazardous jobs such as a commercial diver or a commercial fisherman, or wherein the hobbies of the individual include flying a private plane, etc.

In certain embodiments of the invention, the owner and beneficiary of the long-term disability insurance policy is the retirement plan trust and not the individual participants or individual or group trusts set up outside the retirement plan.

According to the present invention, the premiums are paid by the employer and are tax deductible to the employer.

According to the invention, benefits of the retirement package are based on actual contributions (up to qualified plan limits). According to the invention, the benefits are deferred until normal retirement age.

In particular, although the disabled recipient would not be classified as an active employee and therefore normally would not be eligible to make elective contributions to the retirement plan, in accordance with the present invention the benefits paid under the long-term disability insurance contract are designed to correspond to the elective deferral as well as employer contribution amounts that were being made to the plan by the recipient prior to disability. In this manner, the benefit is somewhat analogous to a “waiver of premium” benefit typically provided as a rider to conventional insurance contracts such as life insurance, wherein premiums due under the insurance contract are automatically paid upon the disability of the insured.

The plan is sold to the employer, so contributions are deductible on the employer's tax return.

Further embodiments of the invention concern the computer program for operating the insurance policy.

In certain further embodiments of the invention, the disability insurance premiums are reported as income to the recipients; therefore, benefits are tax-free to participants at retirement up to their policy basis.

Certain further embodiments of the invention concern the computer program by which the insurance methods are executed.

In certain embodiments, the program has computer readable and computer executable media that itself contains a plurality of computer programs, algorithms, software applications, including operations and procedures of the insurance method encoded as computer readable and computer executable program code in the form of a program product. Still further, the program can have algorithms, software applications, including operations and procedures of the insurance method involving payment methods of a premium and any financing options generated by the program. In practice, the user would enter into the program from a computer. The employer would be able to contribute to the plan by using a credit card number and other necessary information needed for payment. Alternatively, the computer program allows for future payment by financing, cash, check, or other valuable items to be delivered to an insurance agent or insurance company controlling the program.

In certain embodiments, the insurance method can be implemented in software, firmware or hardware or a combination of each. In certain embodiments, the insurance method is implemented in software as an executable program code which comprises an ordered listing of executable instructions for implementing logical functions and which is executed by a server.

In certain embodiments, the insurance method is implemented in a server having a processor as a processor. The processor is a hardware device for executing software including software stored in the memory and in the program unit, including a program encoded as the reimbursement insurance method. The processor can be any custom made or commercially available, off-the-shelf processor, a central processing unit (CPU), one or more auxiliary processors, a semiconductor-based microprocessor, in the form of a microchip or chip set, a macroprocessor or generally any device for executing software instructions. The memory and the dynamic repository and the storage device or devices, and the plurality of databases can include any one of or a combination of volatile memory elements, including random access memory (including RAM, DRAM, SRAM and/or SDRAM) and non-volatile memory elements including read only memory (including ROM, erasable programmable read only memory, electronically erasable programmable read only memory EEPROM, programmable read only memory PROM, and/or compact disc read only memory CD-ROM or FLASH memory) magnetic tape, disk, diskette, cartridge, cassette and/or optical memory. The memory can have an architecture where various components are situated remotely from one another, but can be accessed by the processor.

Operation

In operation, in certain embodiments of the invention, the method disclosed herein defers paying disability benefits until retirement. In certain further embodiments, after satisfying an elimination period, benefits are paid by an underwriter, such as Lloyd's, into an annuity with the annuity held in trust. In certain further embodiments, after five years of disability status, the underwriter, such as Lloyd's, will pay a lump sum into the annuity. At retirement, a stream of income is payable directly by the annuity carrier to the participant to supplement his retirement income.

Further in operation, in certain embodiments, when calculating a covered individual's monthly benefit, the contribution for any month before the effective date of the group master policy will be the recipient's total contributions in the 12 months before the effective date of the group master policy divided by 12. If no contributions have been credited to the recipient's Retirement Account in the previous 12 months, then the monthly benefit is zero. While this embodiment contemplates monthly benefits, we contemplate that the benefits can be daily, weekly, bimonthly, every six months and so on in certain applications.

Still further in operation, in certain further embodiments, if the covered individual becomes disabled, the recipient's monthly benefit during the first year of disability remains the same as it was on the day he/she become disabled. While the recipient's disability continues, the recipient's monthly benefit will increase on each anniversary of the date the disability began. In certain embodiments, it will be 3% more than it was one year earlier, for example. If his/her disability ends and he/she returns to the eligible class, his/her monthly benefit will be calculated as defined.

Further in operation, premiums are paid by the employer. Premiums are tax deductible for the employer. The assets are held in a bank trust department. Benefits are based on actual contributions. Benefits are deferred until normal retirement age. There is no individual underwriting insurability.

In one embodiment, the benefit elimination period is 6 months. In another embodiment, the benefit elimination period is 12 months.

In one embodiment, the product is renewable. In another embodiment, there is a three year lock on rates.

In yet another embodiment, there is a cost-of-living adjustment. In an embodiment, the cost-of-living adjustment is 3%. In another embodiment, claims made in the first 12 months are equal to 3% of the recipient's current salary.

In certain further embodiments of the invention, the method is applied for the benefit of commercial pilots, such as airline pilots and air-cargo pilots. In embodiments regarding commercial pilots, a long-term disability, in addition to the foregoing, is a loss of first class medical.

Regarding a first class disability that will prohibit a pilot from operating a commercial aircraft, an examiner conducts a health assessment of a pilot. In general, unless otherwise directed by the FAA, a health examiner must deny the applicant if the applicant has a history of any of the following: 1) diabetes mellitus requiring hypoglycemic medication; 2) angina pectoris; 3) coronary heart disease that has been treated or, if untreated, that has been symptomatic or clinically significant; 4) myocardial infarction; 5) cardiac valve replacement; 6) permanent cardiac pacemaker; 7) heart replacement; 8) psychosis; 9) bipolar disorder; 10) personality disorder that is severe enough to have repeatedly manifested itself by overt acts; 11) substance dependence; 12) substance abuse: 13) epilepsy; 14) disturbance of consciousness and without satisfactory explanation of cause; and 15) transient loss of control of nervous system function(s) without satisfactory explanation of cause.

Further, for a pilot to pass a first class medical examination in order to maintain the ability to fly a commercial aircraft, the examiner must conduct vision and hearing tests. In the visual test, distant vision, intermediate vision, and near vision are assessed. Distant vision must demonstrate 20/20 or better in each eye with or without correction. Intermediate vision must be 20/40 or better in each eye separately, with or without correction, as measured at 32 inches. Near vision must be 20/40 or better in each eye separately, with or without correction, as measured at 16 inches.

Likewise, a pilot must have proper hearing. The hearing must demonstrate that the pilot can hear an average conversational voice in a quiet room, using both ears at 6 feet, with the back turned to the examiner or by passing an audiometric test. In cases where the audiometric is used, at least one ear must hear at 500, 1000, 2000 and 3000 Hz sounds of a minimum of 35, 30, 30 and 40 Db respectively. The other ear must hear sounds of a minimum of 35, 50, 50 and 60 Db respectively.

### EXAMPLES

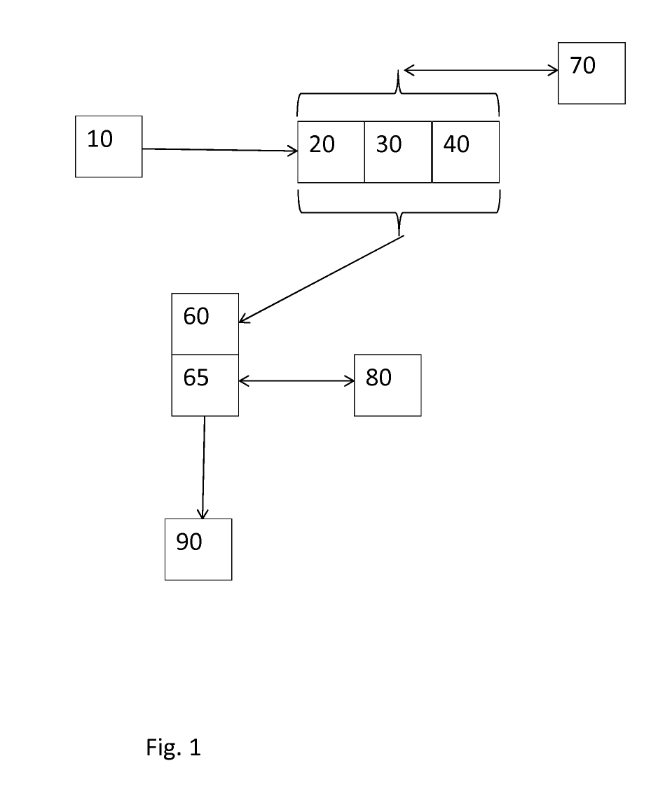

As seen in FIG. 1, an employer 10 pays a premium to financial services company 20 which collects the bills 30 and underwrites the policy 40. Next, the monthly disability claim payments are sent to a trust 50 managed by a bank 60 with an annuities trust 65. The trust then pays an annuity to the disabled employee 75 upon retirement such that the retired employee remains whole as if the employer had contributed to the 401(k) or other retirement package while the employee was off the payroll.

In further aspects pertaining to FIG. 1, to oversee the collection aspect of the financial services company 20, a third party administrator 70 processes the insured claims for the employee benefit program as a separate entity, thus transferring the data between the financial services company 20 which acts as the collection agent, and the third party administer 70 which processes the claims.

In still further aspects pertaining to FIG. 1, a third party trustee annuity advisor 80 oversees the annuity trust 65, and is responsible for adhering to the terms of the trust in the trust document. More specifically, the trustee annuity advisor holds legal title. Further, the trustee annuity advisor 80 selects the annuity provider and selects the annuity to purchase. Upon reaching retirement, the annuity is paid to the disabled recipient 90.

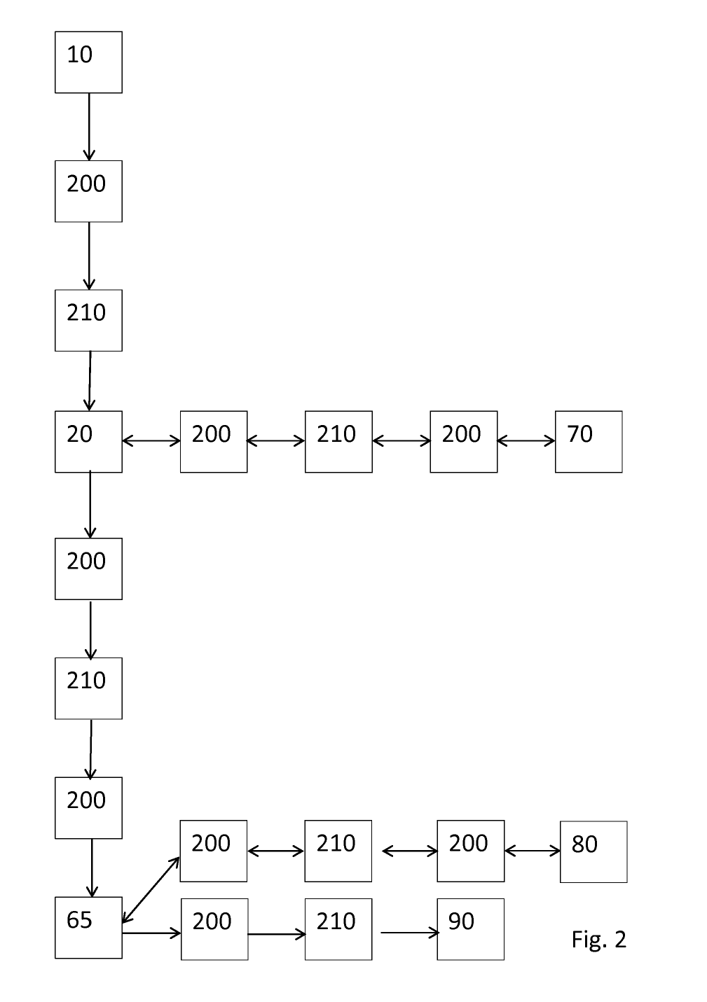

As seen in FIG. 2, the employer 10 enters data into the user interface computer 200. The data entered includes employee information such as name, address, birth date, date of hire, occupation, and job classification.

The computer interface 200, also provides a payment option to the employer such as an option to draw directly from a bank or from a credit card. The data and payment are sent through a network 210 and collected by a financial services company 20. The financial services company 20 transfers data through a user interface 200 and through a network 210 to another user interface 200 controlled by a bank 60 with an annuities trust 65. The third party annuity advisor transmits, via a user interface 200 and through a network 210, instructions to the bank 60 regarding an annuity provider and an annuity to purchase. Likewise, the bank uses a computer interface 200 and a network 210 to transfer fund directly, or indirectly with a check, into the recipient's account upon the recipient reaching retirement age.

Tables 1-3 provide examples if an employee becomes disabled under the plan. The schedule X table is an actuarial table.

TABLE 1

| | |
|---|---|
| Male, age 50 | 200k salary, Contribution Max 401(k), Max |
| | Catch Up Provision, 100% Employer Match |
| | Contribution |

| | | |
|---|---|---|
| Current Salary/70% LTD Plan | Actively | On |
| | At work | disability |
| Current Salary/70% LTD Plan | 200,000 | 140,000 |
| Annual 401(k) Elective Deferral | 23,000 | 0 |
| Taxable Income | 177,000 | 140,000 |
| Tax from Schedule X-Single Table | 43,020 (24.3%) | 32,660 (23.3%) |
| Disposable Income | 133,980 | 107,340 |
| Annual Employer Contribution | 23,000 | |
| Total Annual Retirement | 46,000 | |
| Contribution | | |

Risk for Employee Participant: If disabled, missed contributions
reduce the expected Accumulated Value in 401(k) at age 65
(assuming 5.0% net investment yield).

| | |
|---|---|
| Disabled at start of year 4, on disability for 1 year: | 78,676 |
| Disabled at start of year 4, on disability for 3 year: | 289,692 |
| Disabled at start of year 4, on disability for 5 year: | 478,009 |
| Disabled at start of year 4, on disability through | 709,188 |
| age 65: | |

TABLE 2

| | |
|---|---|
| Female, age 40 | 160k salary, Max 401(k), 100% Employer |
| | Match Contribution |

| | | |
|---|---|---|
| Current Salary/70% LTD Plan | Actively | On |
| | At work | disability |
| Current Salary/70% LTD Plan | 160,000 | 112,000 |
| Annual 401(k) Elective Deferral | 17,500 | 0 |
| Taxable Income | 142,500 | 112,000 |
| Tax from Schedule X-Single Table | 33,360 (23.4%) | 24,820 (23.3%) |
| Disposable Income | 109,140 | 87,180 |
| Annual Employer Contribution | 17,500 | |
| Total Annual Retirement | 35,000 | |
| Contribution | | |

Risk for Employee Participant: If disabled, missed contributions
reduce the expected Accumulated Value in 401(k) at age 65
(assuming 5.0% net investment yield).

| | |
|---|---|
| Disabled at start of year 4, on disability for 1 year: | 62,855 |
| Disabled at start of year 4, on disability for 3 year: | 179,728 |
| Disabled at start of year 4, on disability for 5 year: | 285,736 |
| Disabled at start of year 4, on disability through | 602,454 |
| age 65: | |

TABLE 3

| | |
|---|---|
| Male, age 40 | 100k salary, Max 401(k), 8% Employer |
| | Contribution Profit Sharing Plan |

| | | |
|---|---|---|
| Current Salary/60% LTD Plan | Actively | On |
| | At work | disability |
| Current Salary/60% LTD Plan | 100,000 | 60,000 |
| Annual 401(k) Elective Deferral | 16,000 | 0 |
| Taxable Income | 84,000 | 60,000 |
| Tax from Schedule X-Single Table | 17,030 (20.3%) | 11,030 (18.4%) |
| Disposable Income | 66,790 | 48,970 |
| Annual Employer Contribution | 8,000 | |
| Total Annual Retirement | 24,000 | |
| Contribution | | |

Risk for Employee Participant: If disabled, missed contributions
reduce the expected Accumulated Value in 401(k) at age 65
(assuming 5.0% net investment yield).

| | |
|---|---|
| Disabled at start of year 4, on disability for 1 year: | 60,647 |
| Disabled at start of year 4, on disability for 3 year: | 173,414 |
| Disabled at start of year 4, on disability for 5 year: | 275,697 |
| Disabled at start of year 4, on disability through | 781,583 |
| age 65: | |

From the foregoing description, one of ordinary skill in the art can easily ascertain the essential characteristics of this disclosure, and without departing from the spirit and scope thereof, can make various changes and modifications to adapt the disclosure to various usages and conditions. For example, we do not mean for references such as above, below, left, right, and the like to be limiting but rather as a guide for orientation of the referenced element to another element. A person of skill in the art should understand that certain of the above-described structures, functions, and operations of the above-described embodiments are not necessary to practice the present disclosure and are included in the description simply for completeness of an exemplary embodiment or embodiments. In addition, a person of skill in the art should understand that specific structures, functions, and operations set forth in the above-described referenced patents and publications can be practiced in conjunction with the present disclosure, but they are not essential to its practice.

The invention can be embodied in other specific forms without departing from its spirit or essential characteristics. A person of skill in the art should consider the described embodiments in all respects only as illustrative and not restrictive. The scope of the invention is, therefore, indicated by the appended claims rather than by the foregoing description. A person of skill in the art should embrace, within their scope, all changes to the claims which come within the meaning and range of equivalency of the claims. Further, we hereby incorporate by reference, as if presented in their entirety, all published documents, patents, and applications mentioned herein.

1. A computer implemented method for pension supplementation when an employee has a long-term disability, the computer implemented method comprising:
a) an employer computer for sending and retrieving data, wherein the employer computer is connected by a network;
b) a financial services computer for sending and receiving data, wherein the financial services computer is connected to the network and the network is connected to the employer computer, and wherein the employer computer sends funds and data through the network to the financial services computer;
c) a bank computer for sending and receiving data, wherein the interface is connected to the network and the network is connected to the financial services computer, and wherein the financial services computer sends funds through the network to the bank computer; and
wherein the employer computer sends funds and data of the employee upon disablement via the network to the financial services computer, the financial services computer sends the funds via the network to the bank computer, and wherein the bank computer disperses funds to the employee upon the employee reaching retirement age.

2. The method of claim 1, wherein the financial services computer sends data through the network to a third party administrator computer.

3. The method of claim 2, wherein the third party administrator computer sends data through the network to the financial services computer, the data comprising processed insurance claims on an employee benefit program for the employee.

4. The method of claim 1, wherein the bank computer sends data through the network to a third party trustee annuity advisor computer.

5. The method of claim 4, wherein the third party trustee annuity advisor computer sends data through the network to the bank computer, the data comprising instructions on selecting an annuity provider, selecting an annuity to purchase, instructions on adhering to the terms of the trust, or a combination thereof.

6. The method of claim 5, wherein the financial services computer sends data to a cash flow trustee computer operatively connected to the bank computer, the cash flow trustee computer further being operatively connected to an annuities trustee computer.

7. The method of claim 6, wherein the third party trustee annuity advisor computer sends data through the network to the annuities trustee computer.

8. The method of claim 1, wherein the employer computer sends data through the network to the financial services computer comprising the employee's age, retirement benefit contribution plan, type of injury, expectation of duration of disability, employee's gender, employee's health conditions, employee's previous injuries or a combination thereof.

9. The method of claim 1, wherein the financial services computer sends data through the network comprising the processed insurance claims on the employee benefit program for the employee to an underwriter computer and vice versa.

10. The method of claim 1, wherein the data sent by the financial services computer to the bank computer comprises monthly disability claim payments for the benefit of the employee, a final lump sum payment for the benefit of the employee or a combination thereof.

11. The method of claim 1, wherein the bank computer sends annuity payments at the employees' retirement to a second bank computer in which the employee has an account.

12. The method of claim 1, where the employer computer sends funds to the financial services computer for as long as the employee is disabled.

13. A system comprising a plurality of networked computers for sending and receiving data, the system comprising:
an employer computer operated by the employer of a policy holder, the policy holder having a long-term disability;
a financial services computer;
a bank computer; and
a bank computer; and
wherein the employer computer sends funds and data for the benefit of the policy holder via the network to the financial services computer, the financial services computer sends the funds and data via the network to the bank computer, and wherein the bank computer disperses funds to the policy holder upon the policy holder reaching retirement age.

14. The system of claim 13, further comprising a third party administrator computer connected to the network wherein the financial services computer sends data through the network to the third party administrator computer and wherein the third party administrator computer sends data to the financial services computer comprising processed insurance claims on an employee benefit program for the policy holder.

15. The system of claim 13, further comprising a third party trustee annuity advisor computer connected to the network wherein the third party trustee annuity advisor computer sends data through the network to the bank computer, the data comprising instructions on selecting an annuity provider, selecting an annuity to purchase, instructions on adhering to the terms of the trust, or a combination thereof.

16. The system of claim 13, further comprising a cash flow trustee computer and an annuities trustee computer wherein the cash flow trustee computer and the annuities trustee computer are operatively connected to the bank computer, the cash flow trustee computer further being operatively connected to an annuities trustee computer.

17. The system of claim 16, wherein the third party trustee annuity advisor computer sends data through the network to the annuities trustee computer.

18. The system of claim 13, wherein the data transmitted from the employer computer comprises policy holder's age, retirement benefit contribution plan, type of injury, expectation of duration of disability, employee's gender, employee's health conditions, employee's previous injuries or a combination thereof.

19. The system of claim 13, further comprising an underwriter computer connected to the network, and wherein the financial services computer transmits data to the underwriter computer comprising processed insurance claims on a policy holder benefit program for the policy holder.

20. The system of claim 13, wherein the data sent by the financial services computer to the bank computer comprises monthly disability claim payments for the benefit of the policy holder, a final lump sum payment for the benefit of the policy holder or a combination thereof.
